(19) United States
(12) Patent Application Publication
(10) Pub. No.: US 2016/0201986 A1
(43) Pub. Date: Jul. 14, 2016

(54) SUBSTRATE HOLDER ASSEMBLY, APPARATUS, AND METHODS

(71) Applicant: Applied Materials, Inc., Santa Clara, CA (US)

(72) Inventors: Edwin Velazquez, Union City, CA (US); Ekaterina Mikhaylichenko, San Jose, CA (US); Kyle M. Hanson, Kalispell, MT (US); Jonathan P. Domin, Sunnyvale, CA (US); Jim K. Atkinson, Los Gatos, CA (US)

(21) Appl. No.: 14/593,841

(22) Filed: Jan. 9, 2015

(51) Int. Cl. F26B 5/12

(52) U.S. Cl. CPC F26B 5/12

(57) ABSTRACT

In one or more embodiments, a substrate holder apparatus is provided. A substrate holder apparatus includes a frame having multiple substrate contact supports configured to contact and support a substrate, and one or more vacuum ports configured to apply a vacuum at one or more locations along a bottom edge of a substrate. The one or more vacuum ports provide air outflow that removes liquid and/or residue along a bottom edge of the substrate after immersion into a tank. Assemblies including the substrate holder apparatus and methods of cleaning substrates with the substrate holder apparatus are provided, as are additional aspects.

### FIELD

Embodiments of the invention relate generally to electronic device manufacturing including chemical mechanical planarization (CMP), and more particularly to substrate holder apparatus adapted for cleaning substrates after CMP.

### BACKGROUND

After a chemical mechanical planarization (CMP) process is performed on a substrate (otherwise referred to as a “substrate”), the substrate typically is cleaned to remove unwanted debris and particles therefrom. For example, slurry, polished substrate material, or other residue may cling to the substrate, including the edge bevel of the substrate. Following CMP, substrates may be post-cleaned in a cleaning module such as a scrubber brush box, a megasonic tank, or the like to remove such unwanted material. Prior to the post-clean, and even after the post-clean, a rinse in a rinse tank may be used in some embodiments.

During the rinsing operations, the substrates may be dried upon being removed from the rinsing tank. Such drying is typically accomplished by use of an air knife, such as a Marangoni knife. However, some bath residue may be difficult to remove using conventional drying methods.

### SUMMARY

In some embodiments, a substrate holder apparatus for cleaning a substrate is provided. The substrate holder apparatus includes a frame having multiple substrate contact supports configured to contact and support a substrate, and one or more vacuum ports arranged along the frame and operable to apply a vacuum at one or more locations along a bottom edge of a substrate.

In some embodiments, a substrate holder assembly of a cleaning module adapted to clean a substrate is provided. The substrate cleaning module includes a substrate holder apparatus including: multiple substrate contact supports configured to support a substrate in an upright orientation, and one or more vacuum ports configured to apply a vacuum at one or more locations along a bottom edge of a substrate; and a vacuum apparatus coupled to the substrate holder apparatus and configured to apply a vacuum at the one or more vacuum ports.

In some embodiments, a method of cleaning a substrate is provided. The method includes supporting a substrate on multiple substrate contact supports on a frame of a substrate holder apparatus, providing one or more vacuum ports on the frame, and removing liquid from a bottom edge of the substrate by applying a vacuum to the one or more vacuum ports.

Other features and aspects of embodiments of the invention will become more fully apparent from the following detailed description of example embodiments, the appended claims, and the accompanying drawings.

### BRIEF DESCRIPTION OF THE DRAWINGS

Various embodiments of the invention are disclosed in the following detailed description and accompanying drawings.

FIG. 1 illustrates a front view of a substrate holder assembly including a substrate holder apparatus in accordance with one or more embodiments.

FIG. 2 illustrates a rear view of a substrate holder apparatus in accordance with one or more embodiments.

FIG. 3 illustrates a partial top view of a substrate holder apparatus including a vacuum port comprising a slot in accordance with one or more embodiments.

FIG. 4 illustrates a partial perspective view of vacuum port of a substrate holder apparatus co-located with the substrate contact support in accordance with one or more embodiments.

FIG. 5 illustrates a partial perspective view of a substrate holder apparatus showing a substrate contact support and a vacuum port comprising a slot in accordance with one or more embodiments.

FIG. 6 illustrates a side view of a substrate cleaning module including a substrate holder assembly in accordance with one or more embodiments.

FIG. 7 illustrates a partial front view of an alternate vacuum apparatus of a substrate holder assembly including independent control of a vacuum to the vacuum ports in accordance with one or more embodiments.

FIG. 8 illustrates a partial front view of another alternate vacuum apparatus of a substrate holder assembly including independent control of a vacuum to the vacuum ports in accordance with one or more embodiments.

FIG. 9 illustrates a cross sectioned partial view of vacuum port that is co-located with the substrate contact support and showing registry of a substrate in accordance with one or more embodiments.

FIG. 10 is a flowchart of a method of operating a substrate holder apparatus in accordance with one or more embodiments.

### DESCRIPTION

In one or more embodiments of the present invention, a substrate holder assembly including a substrate holder apparatus is provided. Substrate holder apparatus is configured and adapted to hold a substrate during cleaning and drying (e.g., substrate rinsing and drying) and, as will be appreciated from the following, may aid in removal of residue from the substrate. The substrate holder apparatus may aid especially in cleaning the lower edges of the substrate, as well as around the substrate contact locations, and may therefore avoid residue buildup on a lower edge of the substrate, and/or around the substrate contact locations.

In some embodiments, following CMP, substrates may be rinsed in a first post-CMP rinse, and then may be transferred directly to a post-cleaning module, such as a scrubber brush box, a megasonic tank, or the like, for further cleaning. However, during a rinsing and drying process, even with the use of an air-knife or a Marangoni dryer to dry the substrate as it is retracted from the rinse bath, some adhered particles and/or residues may still remain, especially on contact points, and along a bottom edge of the substrate. Thus, embodiments of the present invention provide substrate holder assemblies, substrate holder apparatus, and operational methods that may provide improved residue removal as a substrate is removed from a rinsing bath.

In some embodiments, the substrate holder apparatus includes a frame having multiple substrate contact supports configured to contact and support a substrate, and one or more vacuum ports arranged along the frame. The one or more vacuum ports are operable (i.e., capable of being operated) to apply a vacuum at one or more locations along the bottom edge of a substrate.

In some embodiments, the one or more vacuum ports comprises one or more vacuum ports located substantially at a same location as the one or more substrate contact supports, which may include V-notches. As such, residue, which formerly would collect at such substrate contact support locations, is removed by the operation of one or more embodiments of the invention.

In one or more embodiments, the substrate holder apparatus may include one or more vacuum ports that are located on the frame of the substrate holder apparatus and positioned proximate to a lower edge of the substrate. The vacuum ports are operated to aid in residue removal along the lower edge, as the substrate is withdrawn from the rinsing bath. In some embodiments, the vacuum ports are operated in synchronism with an air knife or Marangoni dryer to assist in a substantially complete removal of the rinse liquid from the lower edge. In some embodiments, the one or more vacuum ports comprise one or more slots.

As used herein unless otherwise specified, the term “clean” is intended to mean the removal of liquid, residue, or other particles that have become adhered to a substrate. The substrate holder apparatus may be used to hold a substrate as it undergoes a cleaning method, such as a post-CMP cleaning method.

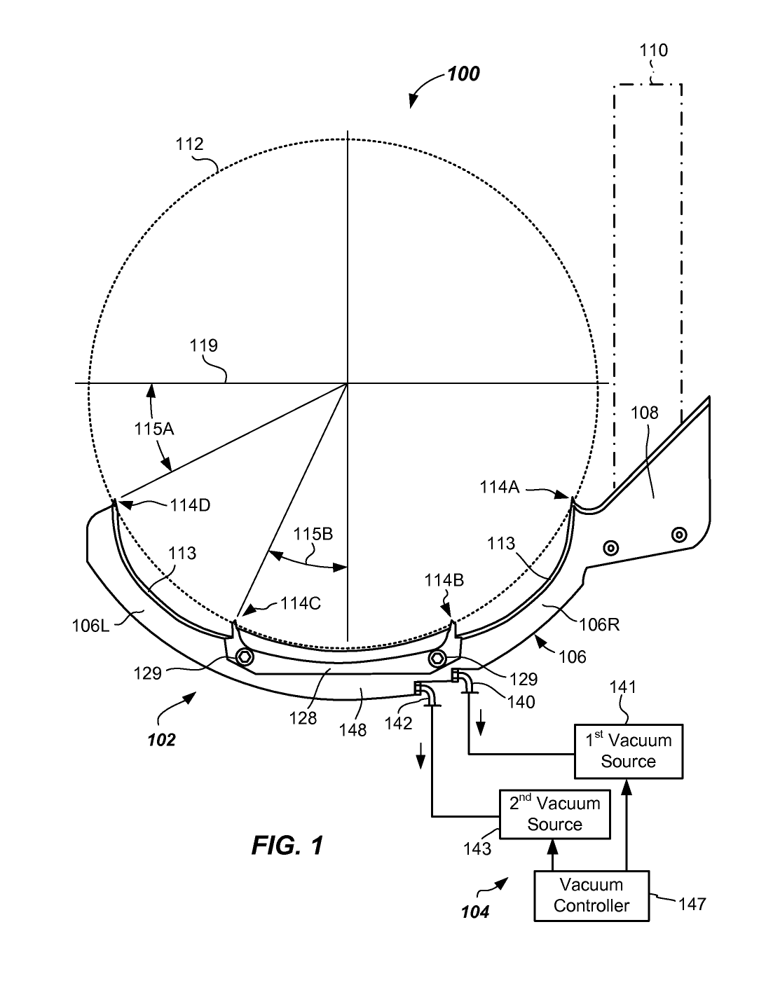

These and other features and embodiments of the invention will be described in more detail with reference to FIGS. 1-10 herein.

FIG. 1 is a front view of an example of a substrate holder assembly 100. Substrate holder assembly 100 has utility for holding a substrate, lowering the substrate into a bath (e.g., into a rinsing bath) and aiding in the removal of the substrate from the bath in semiconductor device processing. Substrate holder assembly 100 includes a substrate holder apparatus 102 and a vacuum apparatus 104 coupled to the substrate holder apparatus 102. Vacuum apparatus 104 is configured to provide a source of vacuum to the substrate holder apparatus 102.

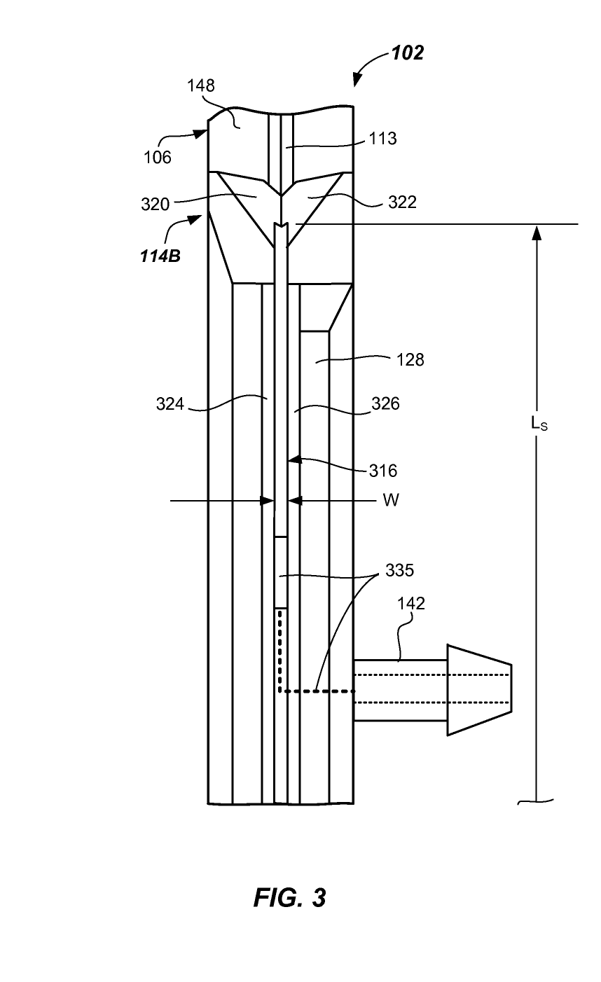

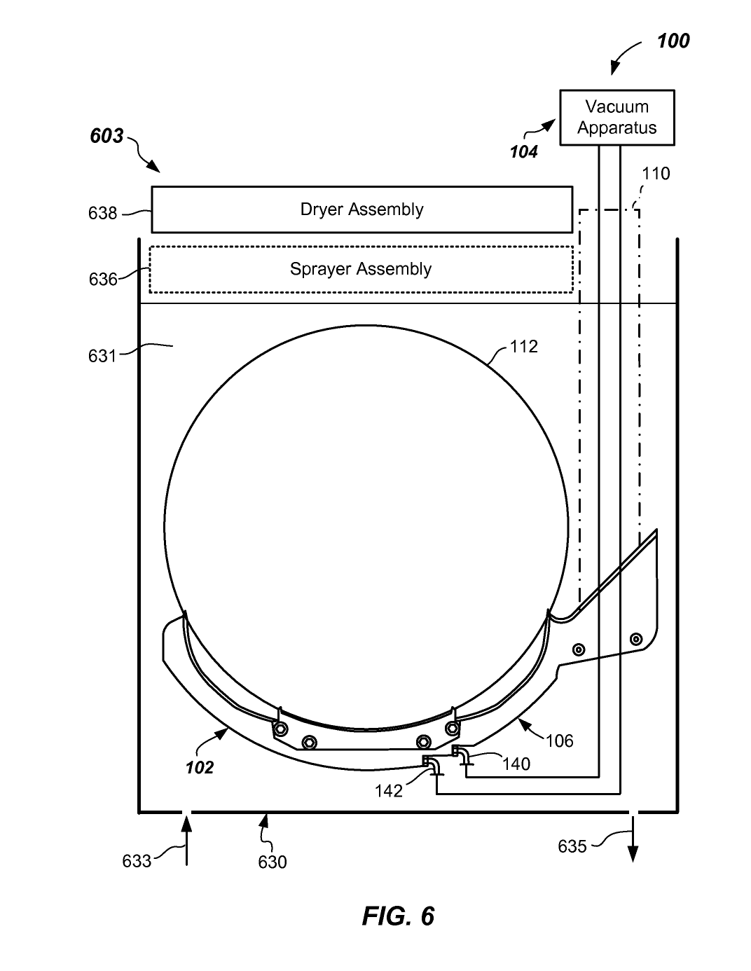

Substrate holder apparatus 102 includes a frame 106, which may include a connecting portion 108 configured to attach to a lift 110 by suitable fasteners (e.g., bolts, screws or the like). Lift 110 may be a part of a robot (not shown) that is adapted to, lower, lift and/or position the substrate holder apparatus 102 within a tank (see FIG. 6). Frame 106 may extend below the substrate 112, and may be made of a rigid material, such as stainless steel, aluminum, ceramic, or various plastics. Other suitable materials may be used. Frame 106 may include a V-shaped upper contour 113 (see FIGS. 3-5) along an upper perimeter to aid in liquid removal as the substrate holder apparatus 102 is lifted from a cleaning liquid 631 contained in a tank 630 (FIG. 6). The frame 106 may further include a right side 106R and a left side 106L. As shown, right side 106R is configured to support a substrate 112 (shown dotted) on the lower right side thereof, and left side 106L is configured to support a substrate 112 on the lower left side thereof.

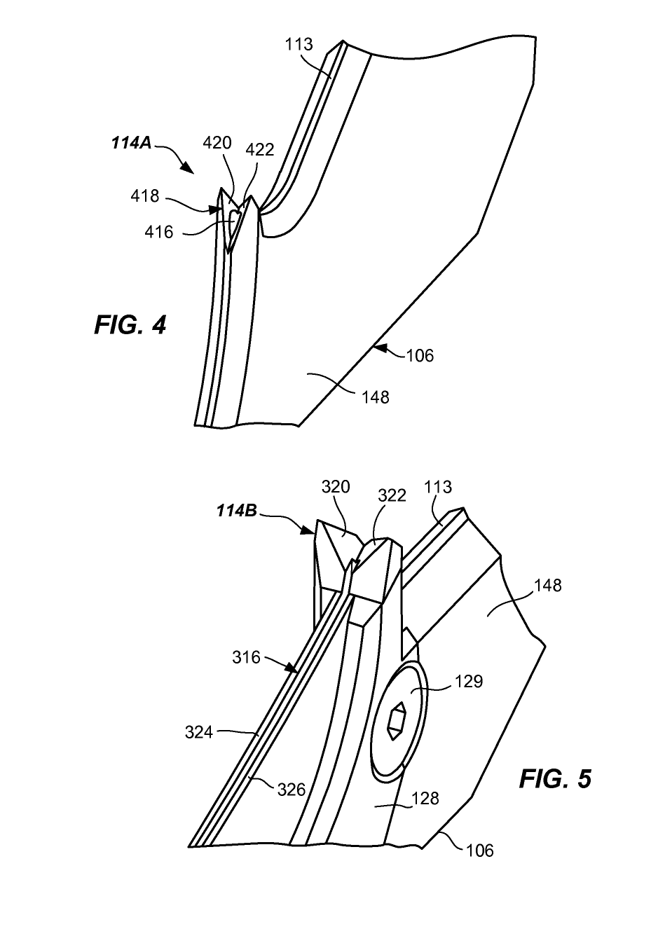

In the embodiment shown, the substrate 112 is held in a vertical orientation by multiple substrate contact supports 114A-114D. Multiple substrate contact supports 114A-114D are configured to contact and support the substrate 112. The multiple substrate contact supports 114A-114D may comprise the four substrate contact supports, as shown, but may also comprise three or more substrate contact supports in some embodiments. Substrate contact supports 114A, 114D (e.g., upper substrate contact supports) may be positioned at a first angle 115A of between about 0° and about 50° below the horizontal as shown, with the first angle 115A being about 25° in some embodiments. Substrate contact supports 114B, 114C (e.g., lower substrate contact supports) may be positioned at a second angle 115B of between about 0° and about 50° from the vertical as shown, and second angle 115B may be about 25° in some embodiments. Substrate contact supports 114A-114D may each comprise v-grooves. V-groove 418, as best shown in FIG. 4, includes first and second inclined sides 420, 422 forming a V-shaped notch. V-groove 418 may have an acute angle between the first and second inclined sides 420, 422 of between about 30° and about 120°, of even between about 60° and about 120°, and of about 90° in some embodiments. Other acute angles may be used.

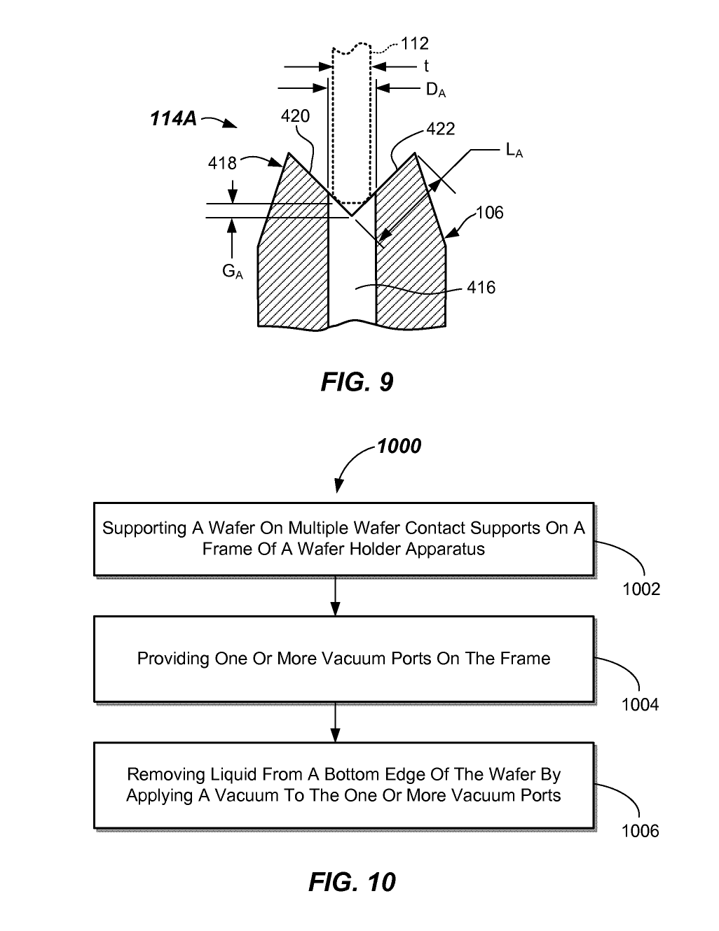

As shown in FIG. 9, each of the first and second inclined sides 420, 422 of the V-groove 418 may have a length L_{A} of between about 0.5 mm and about 10 mm, and about 5 mm in some embodiments. Other sizes and shapes of the substrate contact supports 114A-114D may be used to secure the substrate 112 and assist with handoff. For example, in some embodiments, a slight radius may be included at the bottom vertex at the intersection of the first and second inclined sides 420, 422.

Substrate holder apparatus 102 includes one or more vacuum ports along the frame 106. Examples of vacuum ports 316, 416 are shown in FIGS. 3-5 and 9. For example, a vacuum port 316 is shown in FIGS. 3 and 5, and a vacuum port 416 is shown in FIGS. 4 and 9. Vacuum ports 316, 416 are arranged along the frame 106 and are configured and operable to apply a vacuum at one or more locations along a bottom edge of the substrate 112. “Bottom edge” as used herein means anywhere along the lower half (lower 180°) of the substrate 112, such as below horizontal line 119 in FIG. 1. As best shown in FIGS. 3-5, at least one of the substrate contact supports 114A-114D may comprise a vacuum port (e.g., vacuum ports 316, 416) that is located proximate to the substrate contact support 114A-114D. For example, as shown in FIG. 4, the vacuum port 416 may be substantially co-located with the v-groove 418. Vacuum ports 316, 416, may take the form of a small round opening, an oblong hole, a slot, or the like. Other shapes may be used.

FIG. 4 illustrates a vacuum port 416 comprising a round hole formed into the V-groove 418 and substantially co-located with the first and second inclined sides 420, 422 thereof. For example, the vacuum port 416 may be formed proximate the vertex of the V-groove 418. Vacuum port 416 may include a diameter “D_{A}” (FIG. 9) of greater than about 0.1 mm, and between about 0.5 mm and about 3.0 mm in some embodiments, and about 1.5 mm, for example. In some embodiments, the diameter D_{A} may be greater than a thickness “t” of the substrate 112. Other sizes may be used.

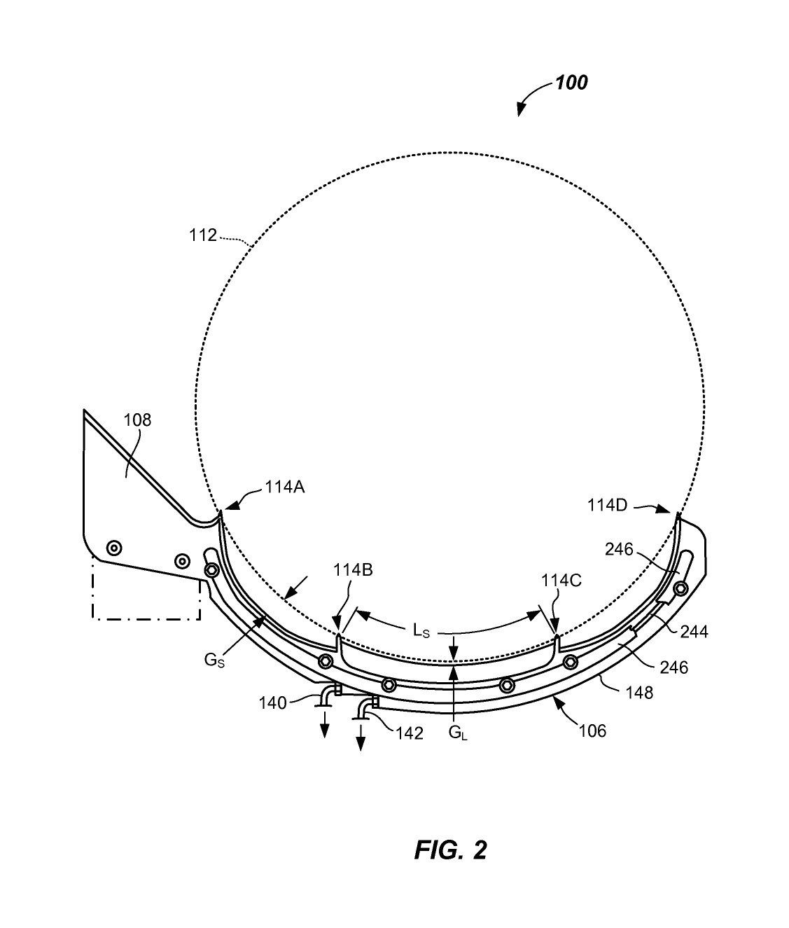

As shown in FIG. 2, vacuum port 416 may fluidly couple to an internal passage 244 to be explained later herein. In the depicted embodiment, the one or more vacuum ports comprises a first vacuum port 416 that is located proximate to the substrate contact support 114A, and a second vacuum port (e.g., identical to first vacuum port 416) that is located proximate to the substrate contact support 114D. A defined gap “G_{A}” (see FIG. 9) may be provided between a radial edge of the substrate 112 as seated in the substrate holder apparatus 100 to the bottom vertex of the V-groove 418. The defined gap “G_{A}” may be greater than about 0.025 mm, and between about 0.025 mm and about 5 mm, for example. Gap “G_{A}” is provided so as not to impede flow and allow a path for cleaning liquid to flow into the vacuum port 416.

These vacuum ports 416 may be connected to a first vacuum outlet 140. Connection to the first vacuum outlet 140 may be formed by the internal passage 244 (FIG. 2). Internal passage 244 may interconnect the first vacuum outlet 140 to the first vacuum ports 416 located at the substrate contact support 114A and also the substrate contact support 114D.

Some portions of the internal passage 244 may be formed by the interaction of a cover 246 and the body 148 of the frame 106 (see broken-out section in FIG. 2). Cover 246 may be attached to body 148 by fasteners (e.g., bolts, screws, or the like). Other portions of the internal passage 244 may be machined as holes into the body 148 of the frame 106 thereby interconnecting the vacuum ports 416 to the covered portion. First vacuum outlet 140 may be connected to a first vacuum source 141 as shown in FIG. 1, which may be a vacuum pump, or other suitable pump or suitable air flow-producing mechanism. Vacuum source 141 may provide a vacuum level sufficient to produce an air outflow rate of greater than 0.5 scfm, and between about 0.5 scfm and about 10 scfm, and about 3.5 scfm in some embodiments. Other vacuum levels may be used to produce different airflow rates.

FIGS. 3 and 5 illustrate a vacuum port 316 comprising one or more slots. In the depicted embodiment, vacuum port 316 comprises a single slot, as shown. Vacuum port 316 may include a slot width “W” (FIG. 3) of greater than about 0.1 mm, and between about 0.1 mm to about 5 mm, and about 0.5 mm, for example. Vacuum port 316 may include a slot arc length “L_{S}” along the slot of greater than about 20 mm, and between about 20 mm to about 300 mm in some embodiments, and about 130 mm, for example. Other slot sizes (lengths “L_{S}” and widths “W”) may be used. Edges of the vacuum port 316 may be maintained in close proximity to the radial edge of the substrate 112 along the slot arc length “Ls.” For example, a defined lower gap “G_{L}” of less than about 6 mm, or even less than 3 mm, or about 1 mm may be provided. Other defined gaps may be used. In areas where the vacuum port 316 is not present, such as between substrate contact supports 114A and 114B, and between substrate contact supports 114C and 114D, the frame 106, and in particular, the upper edge of the frame 106 may be spaced away from the radial edge of the substrate 112. For example, a spacing gap “G_{S}” at a location of maximum separation from the radial edge of the substrate 112 may be greater than 3 mm, greater than 5 mm, or even greater than 10 mm, as shown. Other spacing gaps “G_{S}” may be used.

The vacuum port 316 may span along the lower end of the substrate 112. For example, the vacuum port 316 may extend entirely between the substrate contact support 114B and substrate contact support 114C. One vacuum port 316 (e.g., slot) is shown, but the distance could be serviced (e.g., aiding in drawing off drips, liquid film, and residue from the substrate 112) by using multiple side-by-side oriented slots. For example, one slot may be provided between substrate contact supports 114B, 114C, and an additional slot may be provided between substrate contact support 114A and 114B, or between substrate contact support 114C and 114D, or both.

Vacuum port 316, as shown in FIGS. 3 and 5, may be formed by a first lip 324 and a second lip 326 spaced apart from one another by the width “W.” Second lip 326 may be formed as part of a removable member 128 of the frame 106, which may be secured to the body 148 of the frame 106 by fasteners 129 (e.g., bolts, screws, or the like). First lip 324 may be formed into the body 148.

As shown in FIGS. 3 and 5, right lower substrate contact support 114B may include first and second inclined sides 320, 322 forming a V-groove having a V-shaped notch. First and second inclined sides 320, 322 that may be formed at the same angle, and be of the same size, as discussed above for substrate contact support 114A. However, other sizes and shapes may be used for the substrate contact support 114B, 114C.

As shown, the vacuum port 316 (e.g., slot shown) may extend into or penetrate partway into the substrate contact support 114B, such that some air flow may be supplied at substrate contact support 114B proximate the contact location with the substrate 112. The left lower substrate contact support 114C may be identical in construction as the substrate contact support 114B in some embodiments.

Vacuum port 316 may be interconnected to a second vacuum outlet 142. Connection may be formed by second internal passage 335 (FIG. 3) connecting the second vacuum outlet 142 to the vacuum port 316. Second internal passage 335 may be, at least in part, formed by the interaction of the body 148 and the removable member 128, but may include some machined portion (e.g., drilled portion) near the second vacuum outlet 142. Second vacuum outlet 142 may be connected to a second vacuum source 143, which may be a vacuum pump, pump, or other suitable airflow-generating device. Second vacuum source 143 may provide a vacuum level sufficient to produce airflow rates as discussed above.

As should be recognized, each of the first vacuum source 141 and the second vacuum source 143 may be turned on and operated separately and independently from one another. Control may be provided via control signals from a vacuum controller 147. Vacuum controller 147 may communicate with a robot controller (not shown) in order to coordinate activities during the process of lifting the substrate holder apparatus 102 and applying vacuum to the vacuum ports 316, 416. Thus, it should be apparent that at least two vacuum ports (e.g., 316 and 416) may include individually-controllable flow rates thereat. Vacuum pressure levels and thus airflow rates at the vacuum ports (e.g., 316 and 416) may vary in amount and/or time of application.

The various methods described herein may be implemented by, or under the control of, the vacuum controller 147, which may be, for example, an appropriately programmed computer, work station, or other computing or processing device. Typically a processor (e.g., one or more microprocessors) will receive instructions from a memory or like device, and execute those instructions, thereby performing one or more methods defined by those instructions. Further, programs that implement such methods may be stored and transmitted using a variety of media (e.g., computer readable media) in any manner. In some embodiments, hard-wired circuitry or custom hardware may be used in place of, or in combination with, software instructions for implementation of the processes of various embodiments. Thus, embodiments of the vacuum controller 147 are not limited to any specific combination of hardware and software. The vacuum controller 147 may include various components and devices (e.g., a processor, input and output devices, sensor(s), and the like) appropriate to provide the desired airflow rates.

As shown in FIG. 6, the substrate 112 and substrate holder apparatus 102 are shown immersed in a cleaning liquid 631 contained within a tank 630 of a cleaning module 603. The cleaning module 603 may include a cleaning liquid delivery including one or more liquid flow ports, such as liquid inlet 633 and liquid outlet 635 configured to deliver and extract a cleaning liquid 631, such as deionized (DI) water or a suitable cleaning solution, to and from the tank 630. In some embodiments, the rinsing liquid delivery may be optional or supplemented by sprayer assembly 636, as shown, which may be a water curtain, a series of spray nozzles, spray bars, or other liquid ejection mechanisms to flow, expose, or spray cleaning liquid 631 onto the planar sides and bevels of the substrate 112. Cleaning liquid emanating from the sprayer assembly 636 may be the same or different than the cleaning liquid 631 in the tank 630. Several suitable configurations of a sprayer assembly 636 are described in U.S. Pat. Nos. 6,575,177, 6,328,814, and 6,955,516, for example. Other suitable sprayer assemblies may be used.

With reference again to FIG. 6, the substrate 112 may be loaded into the substrate holder apparatus 102, such as by a separate apparatus (not shown) and lowered into the cleaning module 603 via a raise/lower robot (not shown), which attaches to and moves the lift 110 (shown dotted). Raise/lower robot may be any suitable robot, such as a rack and pinion, linear actuator, gantry robot, beam robot, or the like. Raise/lower robot lowers the substrate 112 into the tank 630 of the cleaning module 603, and optionally past the sprayer assembly 636, which may spray or otherwise expose both sides of the substrate 112 with a cleaning liquid 631. Substrate 112 may be fully immersed in the cleaning liquid 631 contained in tank 630 for a suitable time, and then is extracted from the tank 630. Tank 630 may include megasonic or other cleaning capability (other than just rinsing) in some embodiments.

As the substrate 112 exits the tank 630, it again passes by the sprayer assembly 636 where the substrate 112 may optionally receive a spray of cleaning liquid 631. The substrate 112 may then be pulled through a dryer assembly 638. Dryer assembly 638 may be any suitable device that enables a flow of drying gas at the sides of the substrate 112, such as an air knife or Marangoni dryer, such as taught in U.S. Pat. Nos. 8,869,422 and 8,322,045, for example. Other configurations of the dryer assembly 638 may be used. After the substrate contact supports 114A, 114D exit the cleaning liquid 631 (or pass through the sprayer assembly 636, if used), the first vacuum source 141 may be turned on by a control signal received from the vacuum controller 147 based on the coordination with the position of the substrate holder apparatus 102 from robot controller (not shown).

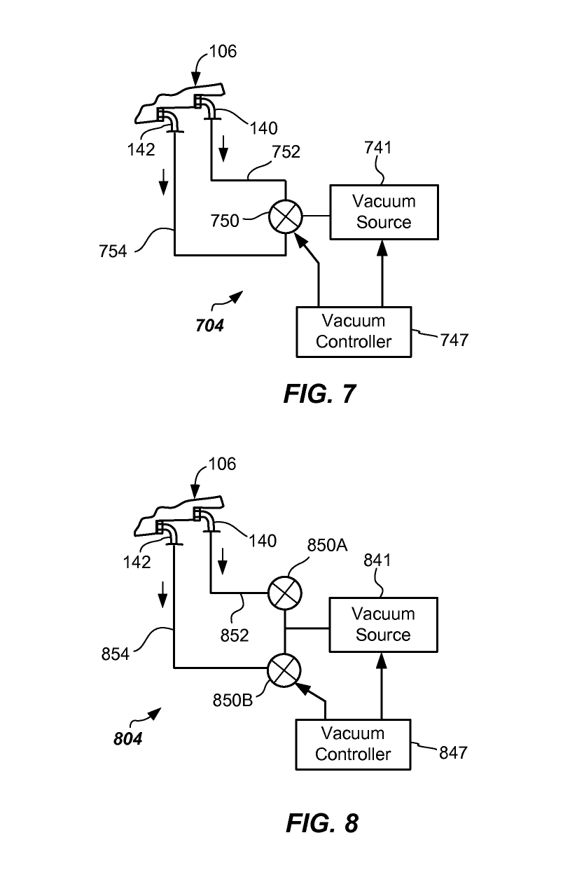

In some embodiments, the vacuum provided at the first vacuum outlet 140 and second vacuum outlet 142 may be provided by a vacuum apparatus 704 including a single vacuum source 741. Single vacuum source 741 may be fluidly coupled to a diversion valve 750, which is fluidly coupled to first conduit 752 and second conduit 754 connected to each of the first vacuum outlet 140 and second vacuum outlet 142, as is shown in FIG. 7. Vacuum may be switched (e.g., diverted) between the respective first and second vacuum outlets 140, 142 at times, as desired, based upon the position of the substrate 112 relative to the dryer assembly 638. For example, opening the diversion valve 750 via signals from the vacuum controller 747 to apply vacuum to, and thus air outflow at, the second vacuum outlet 142 shuts off vacuum to the first vacuum outlet 140, and vice versa. Thus, the vacuum may be supplied first to the vacuum ports 416, which first passes through the dryer assembly 638, followed by applying vacuum to the vacuum ports 316. Therefore, sequentially applied vacuum to the vacuum ports 316, 416 is easily provided.

Optionally, as shown in FIG. 8, a single vacuum source 841 may be fluidly coupled to first and second valves 850A, 850B, which is fluidly coupled to first conduit 852 and second conduit 854, respectively, that are connected to each of the first vacuum outlet 140 and second vacuum outlet 142. Vacuum, and thus air outflow, may be provided to the respective first and second vacuum outlets 140, 142 at times, as desired, based upon the position of the valves 850A, 850B. Thus, vacuum may be provided to one or both of the first and second vacuum outlets 140, 142 as desired for the particular control scheme being implemented.

For example, opening the first valve 850A via signals from the vacuum controller 847, while keeping second valve 850B closed, may to apply vacuum to, and thus air outflow at the first vacuum outlet 140, but no vacuum or outflow to the second vacuum outlet 142. Likewise, opening the second valve 850B via signals from the vacuum controller 847, while keeping first valve 850A closed, may to apply vacuum to, and thus air outflow at the second vacuum outlet 142, but no vacuum or outflow at the first vacuum outlet 140. In this embodiment, both may be opened at the same time, thus providing vacuum and air outflow to both the first vacuum outlet 140 and the second vacuum outlet 142 simultaneously.

The application of air outflow into the vacuum ports 316, 416 assists the dryer assembly 638 in removing liquid and/or residue that may accumulate next to the substrate contact supports 114A, 114D due to, for example, low pressure areas and/or vortex or eddy flows created by the operation of the dryer assembly 638 around the physical structure of the frame 106 and the substrate contact supports 114A, 114D.

As the substrate continues an upward path out of the tank 630, the substrate 112 may continue to be subjected to the spray from the sprayer assembly 636 (if used) and drying from the dryer assembly 638. After the substrate contact supports 114B, 114C pass out of the cleaning liquid 631 and through the sprayer assembly 636 (if used), the second vacuum source 143 may be turned on by a control signal received from the vacuum controller 147. This provides a vacuum along the vacuum port 316 that assists in removing cleaning liquid and residue that may accumulate next to the substrate contact supports 114B, 114C, as well as along the bottom edge of the substrate 112, such as between the substrate contact supports 114B, 114C.

It should be understood that the first vacuum source 141 may be turned off (or valves 750 or 850A may be closed) after the substrate contact supports 114A, 114D pass through the dryer assembly 638 (e.g., air knife). Likewise, the second vacuum source 143 may be turned off (or valves 750 or 850B may be closed) as the substrate contact supports 114B, 114C and lower edge of the substrate 112 pass though the dryer assembly 638. Optionally, both vacuum ports 316, 416 may continue to receive vacuum and provide air outflow until the entire substrate passes through the dryer assembly 638.

In some embodiments, vacuum, and thus air outflow, may be provided to the vacuum ports 316, 416 as they actually pass through the sprayer assembly 636. In this manner, cleaning liquid 631 may be stripped from the surfaces of the substrate 112 and around the substrate contact supports 114A-114D in mass, sort of as an entrained sheet of liquid, which may improve drying.

FIG. 10 illustrates a flowchart of a method 1000 of cleaning a substrate (e.g., substrate 112). The method 1000 may be undertaken following a CMP operation in accordance with embodiments of the present invention. While operation of the substrate holder assembly 100 is described primarily with regard to cleaning (e.g., rinsing) a substrate 112 after a CMP operation, it will be understood that the apparatus and methods may be used elsewhere in the substrate manufacturing process where lowering and raising a substrate 112 into and out of a tank of cleaning liquid (e.g., cleaning liquid 631) is desired, and where substantially complete removal of liquid and/or residue is desired.

With reference to FIG. 10, the method 1000 of cleaning a substrate (e.g., substrate 112) includes, in 1002, supporting a substrate (e.g., substrate 112) on multiple substrate contact supports (e.g., substrate contact supports 114A-114D on a frame (e.g., frame 106) of a substrate holder apparatus (e.g., substrate holder apparatus 102).

The method 1000 includes, in 1004, providing one or more vacuum ports (e.g., vacuum ports 316, 416) on the frame (e.g., frame 106), and, in 1006, removing liquid (e.g., cleaning liquid 631 from the tank 630, and/or liquid from a sprayer assembly 636 (if used)) from a bottom edge of the substrate (e.g., substrate 112) by applying a vacuum (e.g., from the first and second vacuum source 141, 143 or a single vacuum source 741 or 841) to the one or more vacuum ports (e.g., vacuum ports 316, 416).

In some embodiments, the first vacuum (e.g., vacuum applied by the first vacuum source 141 or the single vacuum source 741, 841) may be applied to a first one of the one or more vacuum ports (e.g., to vacuum ports 416), and a second vacuum (e.g., vacuum applied by the second vacuum source 143 or the single vacuum source 741 or 841) may be applied to a second one of the one or more vacuum ports (e.g., to vacuum port 316). Thus, the first vacuum may be applied at a different time than the second vacuum, i.e., the vacuum may be applied sequentially. Vacuum may be shut off to the first vacuum outlet 140 and the second vacuum outlet 142 once the respective vacuum ports 416, 316 have passed through the dryer assembly 638. Shutoff may be sequential or simultaneous. Once the substrate 112 has completed the cleaning operation, it may be moved on to a next processing operation.

The foregoing description discloses only example embodiments of the invention. Modifications of the above-disclosed assemblies, apparatus, and methods which fall within the scope of the invention will be readily apparent to a person of ordinary skill in the art. While embodiments of the invention have been described primarily with regard to cleaning (e.g., rinsing) a substrate after CMP, it will be understood that embodiments of the invention may be employed for other substrate cleaning and/or pre-cleaning applications.

Accordingly, while the invention has been disclosed in connection with example embodiments thereof, it should be understood that other embodiments may fall within the scope of the invention, as defined by the following claims.

The invention claimed is:

1. A substrate holder apparatus, comprising:
a frame having multiple substrate contact supports configured to contact and support a substrate; and
one or more vacuum ports arranged along the frame and operable to apply a vacuum at one or more locations along a bottom edge of a substrate.

2. The apparatus of claim 1 wherein the multiple substrate contact supports comprises three or more substrate contact supports.

3. The apparatus of claim 1 wherein at least one of the multiple substrate contact supports comprises a vacuum port located proximate thereto.

4. The apparatus of claim 1 wherein the one or more vacuum ports comprises a first vacuum port proximate a left upper substrate contact support, and a second vacuum port proximate a right upper substrate contact support.

5. The apparatus of claim 1 wherein the one or more vacuum ports comprises one or more slots.

6. The apparatus of claim 1 wherein the one or more vacuum ports are connected to one or more vacuum sources configured to provide flow rates that vary in one or more of a) a flow rate amount, and 2) a time of application.

7. The apparatus of claim 1 wherein one of the one or more vacuum ports comprises a slot, and the multiple substrate contact supports and the slot are configured to provide a defined lower gap of less than 6 mm between the slot and a radial edge of a substrate when seated in the substrate holder apparatus.

8. The apparatus of claim 1 wherein one of the substrate contact supports comprises a V-groove, and one of the one or more vacuum ports is substantially co-located with the V-groove, and the multiple substrate contact supports and the one of the one or more vacuum ports are configured to provide a defined gap of greater than about 0.025 mm from a bottom vertex of the V-groove to a radial edge of a substrate when seated in the substrate holder apparatus.

9. The apparatus of claim 1 wherein the multiple substrate contact supports comprise v-grooves, and the one or more vacuum ports are located proximate at a location of at least some of the v-grooves.

10. The apparatus of claim 1 wherein the one or more vacuum ports comprises at least two vacuum ports that include individually controllable flow rates thereat.

11. The apparatus of claim 1 comprising at least two vacuum outlets coupled to individual ones of the one or more vacuum ports.

12. The apparatus of claim 1 wherein the frame includes a V-shaped upper contour.

13. The apparatus of claim 1 wherein the frame includes a cover.

14. A substrate holder assembly of a cleaning module adapted to clean a substrate, comprising:
a substrate holder apparatus including:
multiple substrate contact supports configured to support a substrate in an upright orientation, and
one or more vacuum ports configured to apply a vacuum at one or more locations along a bottom edge of a substrate; and
a vacuum apparatus coupled to the substrate holder apparatus and configured to apply a vacuum at the one or more vacuum ports.

15. The substrate holder assembly of claim 14 wherein the vacuum apparatus applies a first vacuum at a first vacuum outlet and a second vacuum at a second vacuum outlet of the substrate holder apparatus.

16. The substrate holder assembly of claim 14, wherein each of the multiple substrate contact supports comprises a v-groove.

17. The substrate holder assembly of claim 14, wherein at least some of the multiple substrate contact supports comprise vacuum ports located thereat.

18. The substrate holder assembly of claim 14, wherein the one or more vacuum ports comprise a slot positioned between at least two of the multiple substrate contact supports.

19. A method of cleaning a substrate, comprising:
supporting a substrate on multiple substrate contact supports on a frame of a substrate holder apparatus;
providing one or more vacuum ports on the frame; and
removing liquid from a bottom edge of the substrate by applying a vacuum to the one or more vacuum ports.

20. The method of claim 19 wherein a first vacuum is applied to a first one of the one or more vacuum ports, and a second vacuum is applied to a second one of the one or more vacuum ports, wherein the first vacuum is supplied at a different time or in a differing amount than the second vacuum.
